(19) United States
(12) Patent Application Publication
(10) Pub. No.: US 2025/0153340 A1
(43) Pub. Date: May 15, 2025

(54) Support Structure for Use with Modular Storage System

(71) Applicant: Milwaukee Electric Tool Corporation, Brookfield, WI (US)

(72) Inventors: Aaron S. Blumenthal, Shorewood, WI (US); Ryan C. Dick, Sussex, WI (US); Aaron M. Williams, Milwaukee, WI (US)

(21) Appl. No.: 19/025,115

(22) Filed: Jan. 16, 2025

Related U.S. Application Data
(63) Continuation of application No. 17/672,331, filed on Feb. 15, 2022, now Pat. No. 12,233,530.
Application No. 17/672,331 is a continuation of application No. PCT/US2022/015816, filed on Feb. 9, 2022.
(60) Provisional application No. 63/164,716, filed on Mar. 23, 2021.
(60) Provisional application No. 63/149,874, filed on Feb. 16, 2021.

(51) Int. Cl. B25H 3/06; B25H 1/06; B25H 1/12

(52) U.S. Cl. CPC B25H 3/06; B25H 1/06; B25H 1/12

(57) ABSTRACT

One or more devices are provided that are configured to detachably engage within a modular system. The one or more devices are positionable to provide a support structure upon which work can be performed.

### CROSS-REFERENCE TO RELATED PATENT APPLICATIONS

The present application is a continuation of U.S. application Ser. No. 17/672,331, filed Feb. 15, 2022, which is a continuation of International Application No. PCT/US2022/015816, filed Feb. 9, 2022, which claims the benefit of and priority to U.S. Provisional Application No. 63/164,716, filed on Mar. 23, 2021, and U.S. Provisional Application No. 63/149,874, filed on Feb. 16, 2021, each of which are incorporated herein by reference in its entirety.

### BACKGROUND OF THE INVENTION

The present disclosure is directed generally to the field of tool storage systems and related devices. The present disclosure relates specifically to a device that includes a support structure and a coupling mechanism to detachably couple the device to another device or container, such as in a modular storage system.

Tool storage units are often used to transport tools and tool accessories. Some storage units are designed to incorporate into a modular storage system. Within a modular storage system, different units, devices and/or containers may provide varying functions, such as providing a device that provides a support structure, such as a saw horse.

### SUMMARY OF THE INVENTION

One embodiment of the invention relates to a foldable support structure including a first wall, a second wall pivotally coupled to the first wall, a third wall pivotally coupled to the first wall, and a first plurality of coupling components. The second wall is pivotally coupled to the first wall such that the first wall and second wall actuate between an open configuration and a closed configuration. The first wall and the second wall are configured to collectively support the foldable support structure in an upright orientation when the second wall and first wall are arranged in an open configuration. The third wall is configured to interface with the second wall when the second wall and first wall are arranged in an open configuration. The first plurality of coupling components extend from a first face of the third wall. The first plurality of coupling components are configured to couple to a lower surface of a stackable storage unit.

Another embodiment of the invention relates to a foldable support system including a first foldable support structure and a second foldable support structure. The first foldable support structure includes a first housing, a first leg pivotally coupled to a first end of the first housing, a second leg pivotally coupled to a second end of the first housing opposite the first end, the first leg and the second leg configured to collectively support the first housing, a first coupling element coupled to the first housing, and a first female coupler coupled to the first housing. The first female coupler is configured to couple to a first surface of a stackable storage unit. The second foldable support structure includes a second housing, a first leg pivotally coupled to a first end of the second housing, a second leg pivotally coupled to a second end of the second housing opposite the first end, the first leg and the second leg configured to collectively support the second housing, a second coupling element coupled to the second housing, and a second female coupler coupled to the second housing. The second coupling element is configured to detachably engage with the first coupling element of the first foldable support structure. The second female coupler is coupled to the second housing. The second female coupler is configured to couple to the first surface of the stackable storage unit.

Another embodiment of the invention relates to a foldable structure includes a housing comprising a first surface and a second surface opposite the first surface, a first leg pivotally coupled to a first end of the housing, a second leg pivotally coupled to a second end of the housing opposite the first end, the first leg and the second leg configured to collectively support the housing, a plurality of male couplers coupled to a first surface of the housing, and a plurality of female couplers coupled to a second surface of the housing. The plurality of male couplers are configured to couple to an upper surface of a stackable storage unit. The plurality of female couplers are configured to couple to a lower surface of a stackable storage unit opposite the upper surface.

Another embodiment of the invention relates to a foldable support structure, such as a saw horse, including a first wall, a second wall pivotally coupled to the first wall, a third wall pivotally coupled to the first wall, and a first plurality of coupling components extending from a first face of the third wall. The foldable work structure is configured to stand in an upright configuration when the second wall is pivoted away from the first wall. The third wall is configured to interface with the second wall when the foldable work structure is configured in an open configuration. The first plurality of coupling components are configured to couple to a first surface of a stackable storage unit.

In a specific embodiment, the foldable support structure includes a second plurality of coupling components extending from a second face of the third wall opposite the first face. The second plurality of coupling components are configured to couple to a second surface of the stackable storage unit opposite the first surface.

Another embodiment of the invention relates to a foldable support system including a first foldable support structure and a second foldable support structure. The first foldable support structure includes a housing, a first leg pivotally coupled to a first end of the housing, a second leg pivotally coupled to a second end of the housing opposite the first end, a first coupling element extending from the housing, and a first plurality of coupling components extending from the housing. The first plurality of coupling components are configured to couple to a first surface of a stackable storage unit. The second foldable support structure includes a housing, a first leg pivotally coupled to a first end of the housing, a second leg pivotally coupled to a second end of the housing opposite the first end, a second coupling element extending from the housing, and a second plurality of coupling components extending from the housing. The second plurality of coupling components are configured to couple to the first surface of a stackable storage unit. The second coupling element is configured to selectively engage with the first coupling element of the first foldable structure.

Another embodiment of the invention relates to a device including a first panel and a second panel pivotally connected to the first panel. The device actuates between an open position, in which the first panel and second panel are pivoted apart, and a closed position, in which the first panel and the second panel are pivoted together. The first panel includes a coupling mechanism engageable to a modular storage unit.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front view of a support structure, according to an exemplary embodiment.

FIG. 2 is a rear view of the support structure of FIG. 1, according to an exemplary embodiment.

FIG. 3 is a perspective view of the support structure of FIG. 1, according to an exemplary embodiment.

FIG. 4 is a perspective view of the support structure of FIG. 1, according to an exemplary embodiment.

FIG. 5 is a detailed perspective view of the support structure of FIG. 1, according to an exemplary embodiment.

FIG. 6 is a perspective view of a modular system including the support structure of FIG. 1, according to an exemplary embodiment.

FIG. 7 is a perspective view of the modular system of FIG. 6 including the support structure of FIG. 1, according to an exemplary embodiment.

FIG. 8 is a perspective view of two support structures, according to an exemplary embodiment.

FIG. 9 is a perspective view of the two support structures of FIG. 8, according to an exemplary embodiment.

FIG. 10 is a side view of the two support structures of FIG. 8 in front of a modular system, according to an exemplary embodiment.

FIG. 11 is a perspective view of the two support structures of FIG. 8 next to the modular system of FIG. 10, according to an exemplary embodiment.

FIG. 12 is a perspective view of the two support structures of FIG. 8 coupled to a front of the modular system of FIG. 10, according to an exemplary embodiment.

FIG. 13 is a perspective view of the two support structures of FIG. 8 next to the modular system of FIG. 10, according to an exemplary embodiment.

FIG. 14 is a perspective view of the two support structures of FIG. 8 next to the modular system of FIG. 10, according to an exemplary embodiment.

FIG. 15 is a perspective view of the two support structures of FIG. 8 next to the modular system of FIG. 10, according to an exemplary embodiment.

FIG. 16 is a perspective view of the two support structures of FIG. 8 next to the modular system of FIG. 10, according to an exemplary embodiment.

FIG. 17 is a perspective view of the two support structures of FIG. 8, according to an exemplary embodiment.

FIG. 18 is a perspective view of a support system, according to an exemplary embodiment.

FIG. 19 is a perspective view of the support system of FIG. 18, according to an exemplary embodiment.

FIG. 20 is a perspective view of the support system of FIG. 18, according to an exemplary embodiment.

FIG. 21 is a perspective view of the support system of FIG. 18, according to an exemplary embodiment.

FIG. 22 is a perspective view of the support system of FIG. 18, according to an exemplary embodiment.

FIG. 23 is a detailed top view of the support system of FIG. 18, according to an exemplary embodiment.

FIG. 24 is a detailed perspective view from above of the support system of FIG. 18, according to an exemplary embodiment.

FIG. 25 is a perspective view of a portion of the support system of FIG. 18, according to an exemplary embodiment.

FIG. 26 is a perspective view of a support system coupled to a modular system, according to an exemplary embodiment.

FIG. 27 is a perspective view of the support system of FIG. 26 in front of the modular system of FIG. 26, according to an exemplary embodiment.

FIG. 28 is a perspective view of the support system of FIG. 26 coupled to a top of the modular system of FIG. 26, according to an exemplary embodiment.

FIG. 29 is a perspective view of the support system of FIG. 26 coupled to a top of the modular system of FIG. 26, according to an exemplary embodiment.

FIG. 30 is a perspective view of the support system of FIG. 26 coupled to the modular system of FIG. 26, according to an exemplary embodiment.

FIG. 31 is a perspective view of a portion of the support system of FIG. 26, according to an exemplary embodiment.

### DETAILED DESCRIPTION

Referring generally to the figures, various embodiments of a device for providing a work structure/surface, such as a support structure, are shown. One or more of the devices are configured to selectively couple and decouple to storage units within a modular storage system. At constructions sites there can be limited support structures and/or platforms to support objects, documents, etc. Described herein are various portable and stackable devices that provide one or more support structures and/or surfaces, such as a collapsible support structure, that can be selectively coupled and decoupled with a modular system, such as a modular tool storage system. It is contemplated herein that the one or more devices described herein are used as a sawhorse and/or in a similar way to how a sawhorse is used.

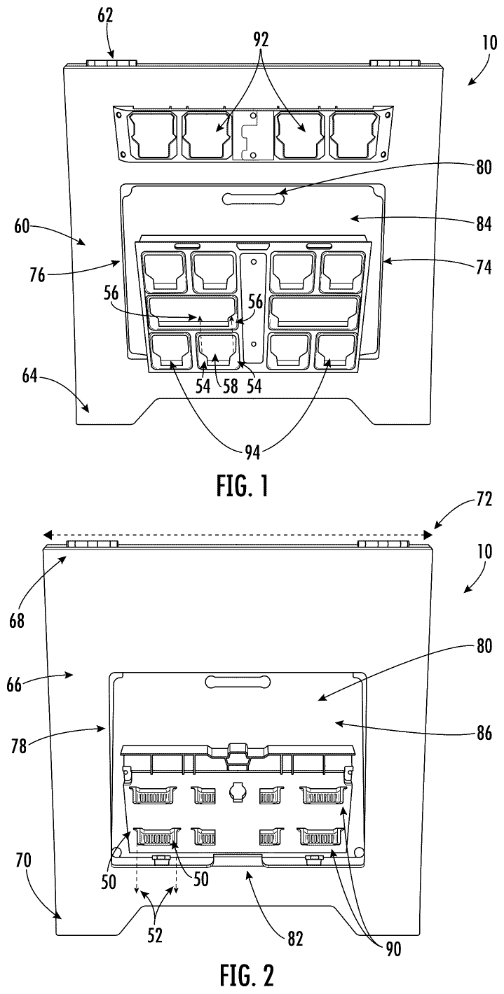

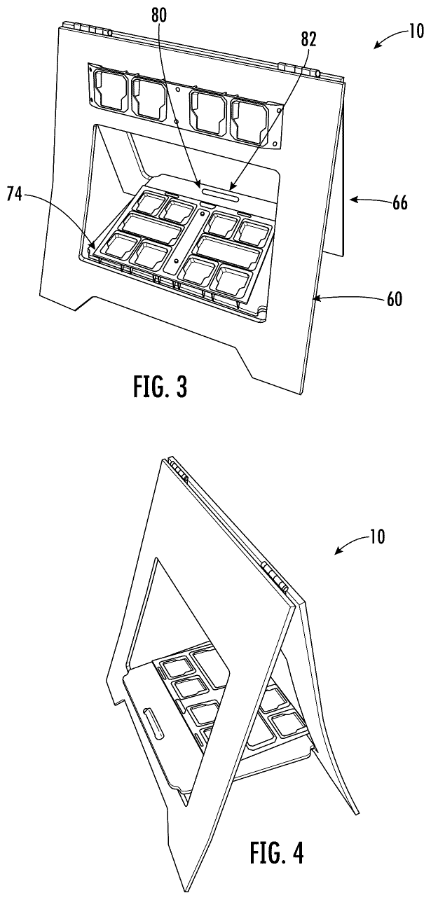

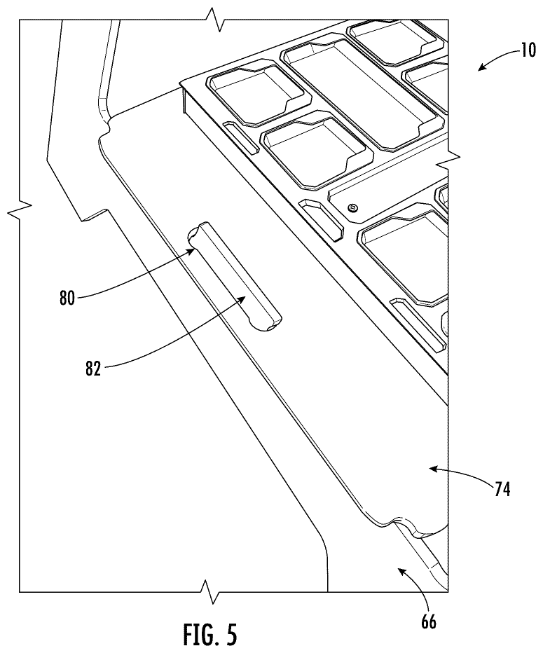

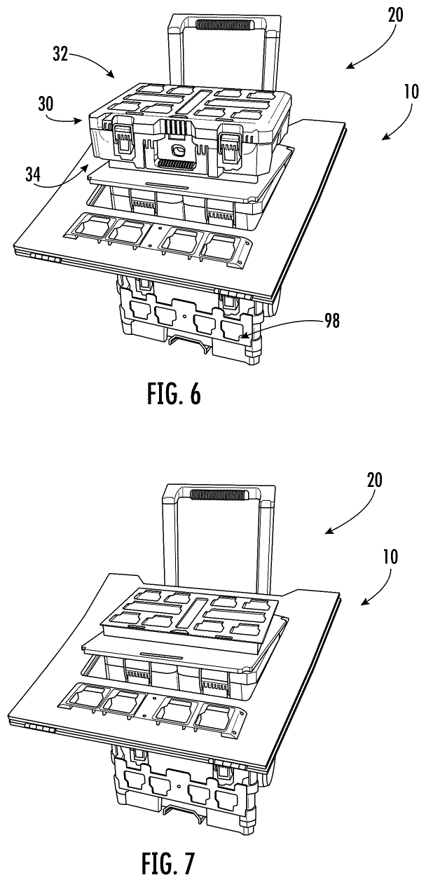

Referring to FIGS. 1-7, various aspects of foldable support structure 10 are depicted. Support structure 10 includes a first support structure, shown as first wall 60, and a second support structure, shown as second wall 66, pivotally coupled to the first wall 60 such that the first wall 60 and second wall 66 actuate between an open configuration and a closed configuration. In a specific embodiment, first wall 60 and second wall 66 are panels. First wall 60 and the second wall 66 are configured to collectively support the foldable support structure 10 in an upright orientation when the second wall 66 and first wall 60 are arranged in an open configuration. Support structure 10 includes one or more coupling mechanisms to couple to a modular system. In FIGS. 1-2, support structure 10 is shown in the closed position such that the first wall 60 and second wall 66 are pivoted together and/or nearly together. In FIG. 3, the first wall 60 and second wall 66 are pivoted open so that support structure 10 can be placed upright on a surface, such as the ground. Referring to FIGS. 6-7, support structure 10 is shown coupled within a modular system, shown as modular storage system 20.

When support structure 10 is positioned in the closed configuration (FIG. 1), lower end 64 of first wall 60 is pivoted towards lower end 70 of second wall 66. When support structure is positioned in the open configuration (FIG. 3), lower end 64 of first wall 60 is pivoted away from lower end 70 of second wall 66 and protrusion 82 from second wall 66 is disposed within aperture 80 of third wall 74 such that third wall 74 biases first wall 60 and second wall 66 to remain in the open configuration. Stated another way, the third wall 74 includes an aperture 80 configured to receive a protrusion 82 extending from the second wall 66 when the third wall 74 is configured in the open configuration and/or foldable support structure 10 is arranged in the upright orientation.

An upper end 62 of first wall 60 is pivotally coupled to an upper end 68 of second wall 66. First wall 60 rotates with respect to second wall 66 about axis 72. Upper end 62 of the first wall 60 and the upper end 68 of the second wall 66 are configured to collectively support an object placed on the foldable support structure 10 (e.g., to support a beam, a platform upon which to work) when the foldable support structure 10 is arranged in the upright orientation.

Third wall 74 is pivotally coupled to first wall 60. Third wall 74 is configured to interface with the second wall 66 when the second wall 66 and first wall 60 are arranged in an open configuration. Third wall 74 actuates with respect to the first wall 60 between a closed configuration and an open configuration in which the foldable support structure 10 is arranged in the upright orientation. In a specific embodiment, opening 76 in first wall 60 is configured to receive third wall 74. In a specific embodiment, opening 78 in second wall 66 is similarly shaped to opening 76 in first wall 60.

In a specific embodiment, first face 84 of third wall 74 includes one or more coupling elements, shown as plurality of coupling components 94. In various embodiments, the plurality of coupling components 94 are configured to couple to a lower surface 34 of a stackable storage unit 30. In a specific embodiment, second face 86 of third wall 74 includes one or more coupling elements, shown as plurality of coupling components 90. In various embodiments, the second plurality of coupling components 90 are configured to couple to an upper surface 32 of the stackable storage unit 30. In a specific embodiment, one or more coupling elements, shown as plurality of coupling components 92, are coupled to and extend from first wall 60 above opening 76.

In various embodiments, the plurality of coupling components 94 include a plurality of female couplers (e.g., each coupling component 94 is a female coupler), each of which include a rib 54 extending along axis 56 above and offset from a recessed portion 58 of the respective female coupler. In various embodiments, the female couplers each include two ribs 54 extending above and offset from a recessed portion 58 of the respective female coupler. In various embodiments, the plurality of coupling components 92 include a plurality of female couplers configured to couple to the lower surface 34 of the stackable storage unit 30, similar to coupling components 94. In various embodiments, the second plurality of coupling components 90 include a plurality of male couplers (e.g., each coupling component 92 is a male coupler), each of which include a tongue 50 extending along axis 52 extending above and offset from the second face 86 of the third wall 74. In various embodiments, the second plurality of coupling components 90 include a plurality of male couplers (e.g., each coupling component 92 is a male coupler), each of which include two tongues 50 extending above and offset from the second face 86 of the third wall 74.

In various embodiments, a first female coupler of the plurality of coupling components 90 (e.g., female couplers) includes a first rib 54 extending along a first axis 56, a first male coupler of the plurality of coupling components 92 (e.g., male couplers) include a first tongue 50 extending along a second axis 52, and the first axis 56 and the second axis 52 are parallel to each other (e.g., the axes are parallel and extending along opposite sides of third wall 74).

In use, plurality of coupling components 90, 92 and/or 94 are configured to be coupled to a modular unit, shown as modular storage unit 30. In a specific embodiment, plurality of coupling components 90 are configured to be coupled to upper surface 32 of modular storage unit 30, and plurality of coupling components 92 and plurality of coupling components 94 are configured to be coupled to lower surface 34 of modular storage unit 30. In another configuration, support structure 10 is coupled to one or more coupling elements, shown as plurality of coupling components 98, on a front of modular storage system 20.

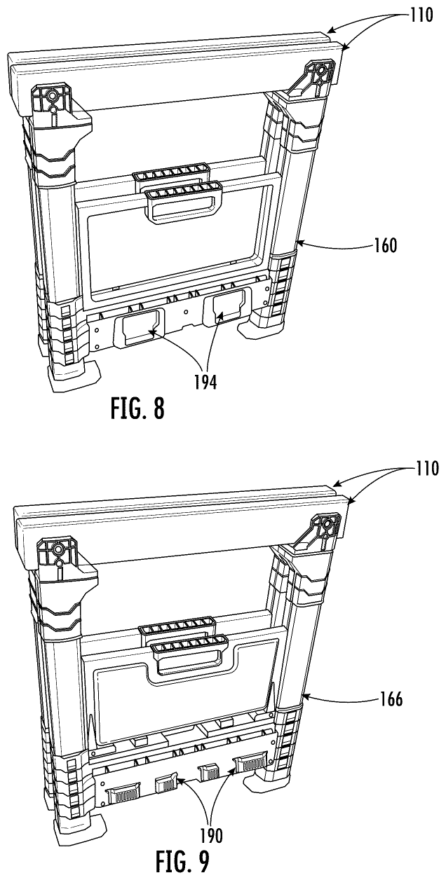

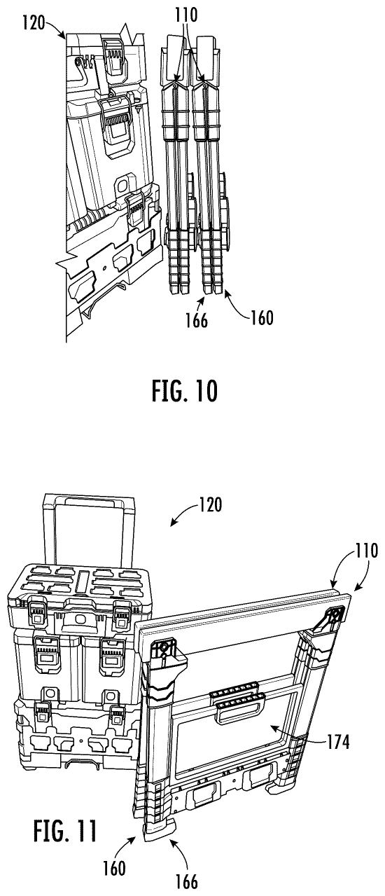

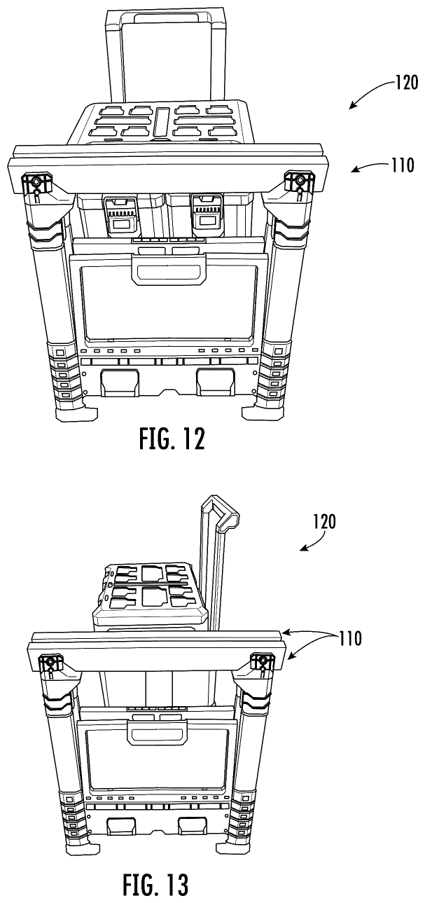

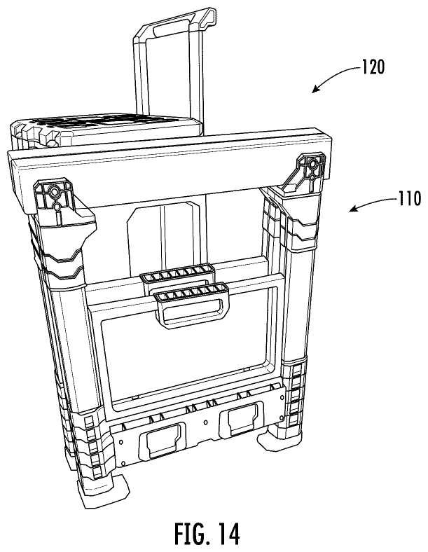

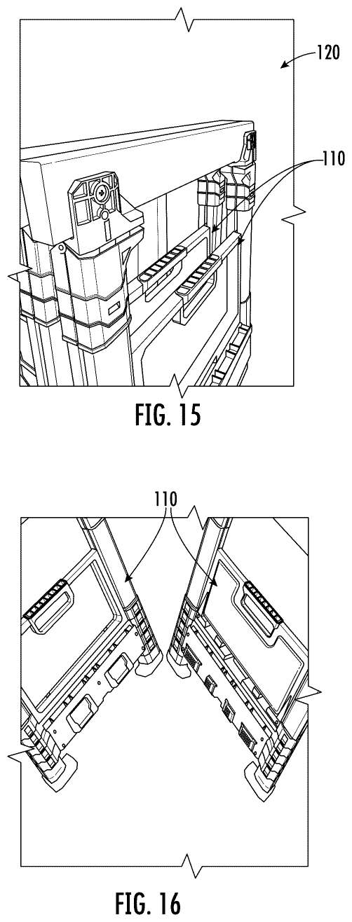

Referring to FIGS. 8-17, various aspects of support structure 110 are depicted. Support structure 110 is substantially the same as support structure 10 except for the differences discussed herein. Support structure 110 includes a first wall 160 and a second wall 166 detachably coupled together. Referring to FIGS. 10-11, support structure 110 can be coupled to a coupling mechanism on a modular system, shown as modular storage system 120. Referring to FIG. 12, support structure 110 is coupled to modular storage system 120 for transporting of support structure 110. Referring to FIG. 16, opposing surfaces of the first wall 160 and the second wall 166 include one or more coupling mechanisms to couple the first wall 160 and second wall 166 together. The coupling mechanisms are compatible with the coupling mechanisms in modular storage system 120.

Third wall 174 extends between first wall 160 and second wall 166. In use, third wall 174 actuates between a horizontal configuration, when support structure 110 is in an open configuration, and a vertical configuration, when support structure 110 is in an closed configuration.

First wall 160 includes one or more coupling elements, shown as plurality of coupling components 194. Second wall 166 includes one or more coupling elements, shown as plurality of coupling components 190.

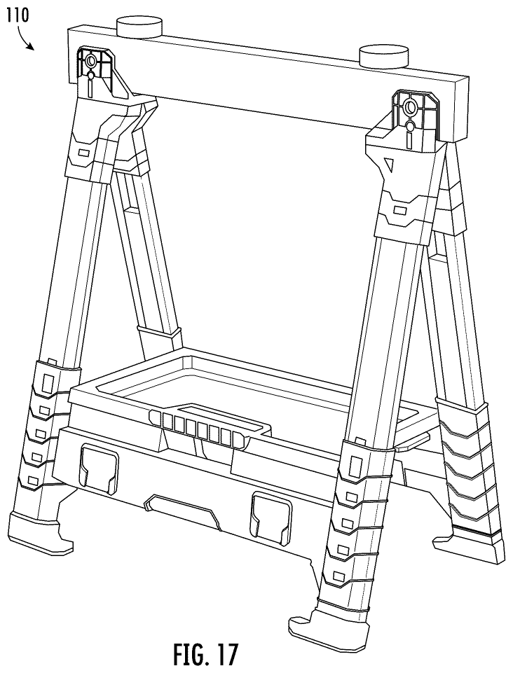

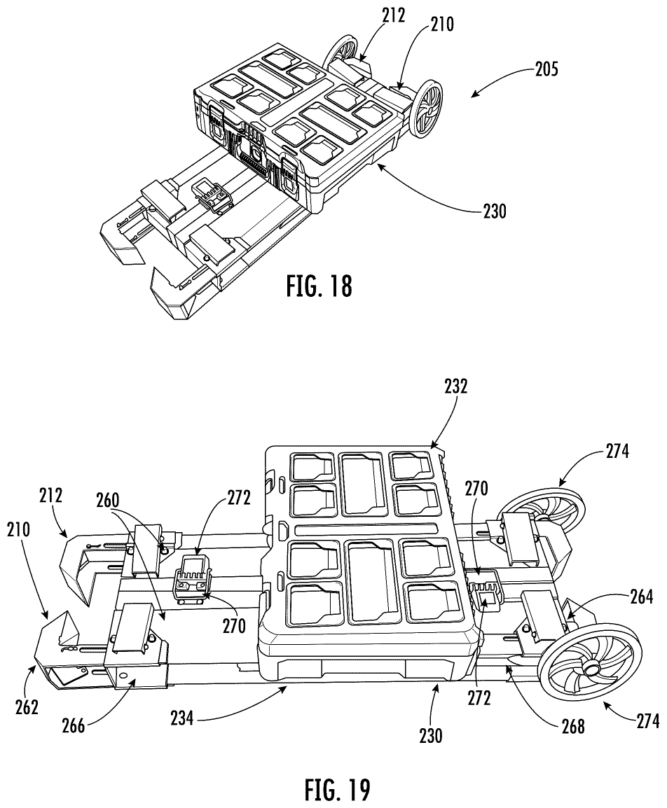

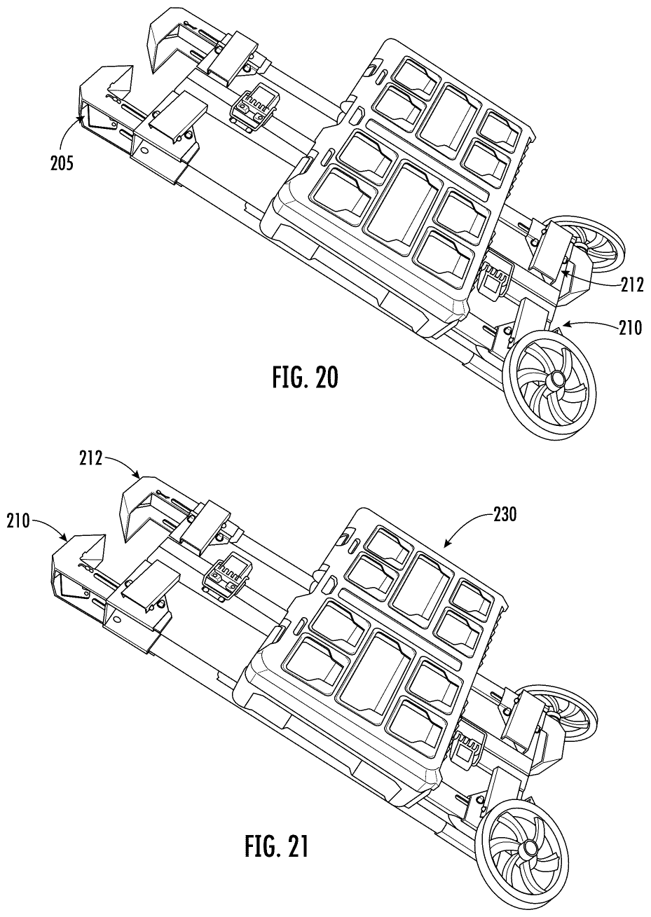

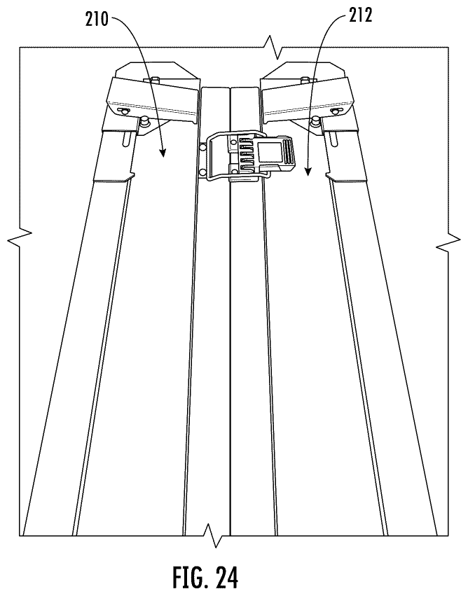

Referring to FIGS. 18-25, various aspects of a foldable support system 205, including two support structures 210, is depicted. Support structure 210 is substantially the same as support structure 10 and support structure 110 except for the differences discussed herein. Support system 205 includes a first support structure 210 and a second support structure 212 coupled together. Second support structure 212 is substantially similar to first support structure 210. A modular and/or stackable unit, shown as modular storage unit 230, is coupled to a top face of the first support structure 210 and the second support structure 212 (FIG. 17). In various embodiments one or more of the first support structure 210 and the second support structure 212 include coupling mechanisms to couple support structure(s) 210, 212 to modular storage unit 230. Referring to FIGS. 19-22, support structure 210 includes a handle for gripping by a user, and one or more moving elements, shown as wheels. Referring to FIGS. 23-24, the first support structure 210 and second support structure 212 are coupled together via one or more securing mechanisms.

Support structure 210 includes housing 260. A first support element, such as a first leg 266, is pivotally coupled to housing 260 at first end 262. A second support element, such as a second leg 268, is pivotally coupled to housing 260 at second end 264 opposite first end 262. The first leg 266 and the second leg 268 are configured to collectively support the housing 260. In use, legs 266, 268 pivot out of housing 260 to support housing 260 in a horizontal orientation above the ground.

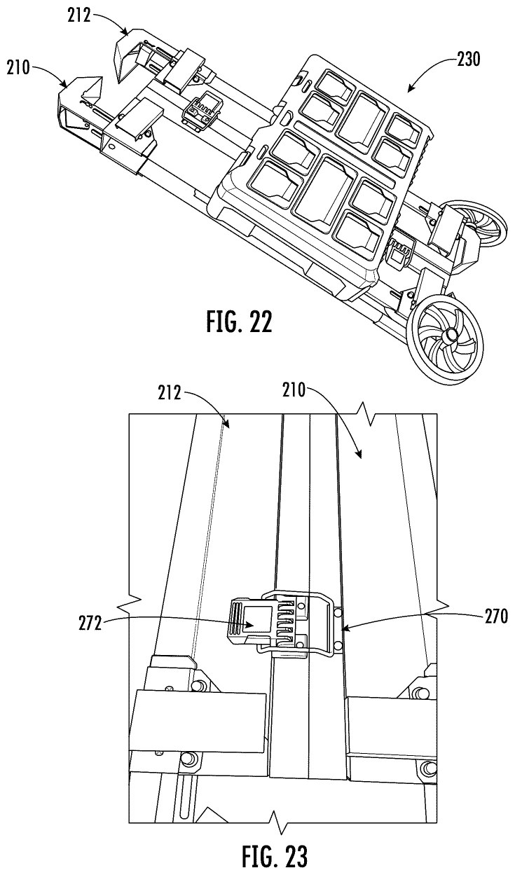

In a specific embodiment, support structure 210 includes first coupling element, shown as lip 270, coupled to housing 260 and a second coupling element, shown as latch 272, coupled to housing 260. In use, two support structures 210 couple together via lip 270 on a first support structure 210 coupling to latch 272 on a second support structure 212 (FIG. 22). In various embodiments, one or more wheels 274 are detachably couple to housing 260.

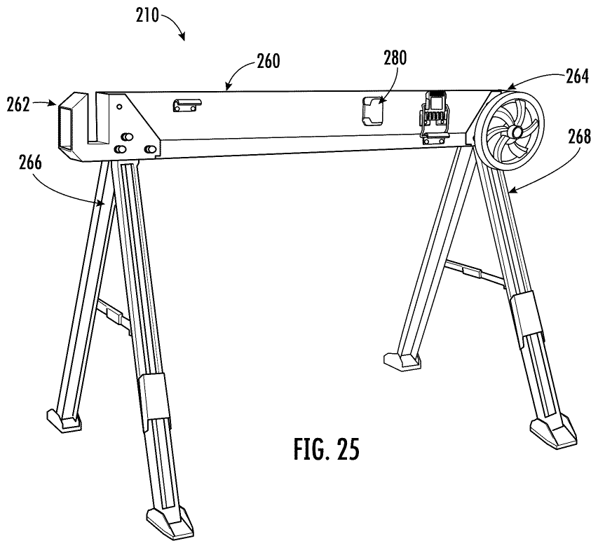

Referring to FIG. 25, female coupler 280 is coupled to housing 260, and the female coupler 280 is configured to couple to a first surface of a stackable storage unit, such as at second end 264. Female coupler 280 is substantially similar to other female couplers described herein, such as coupling components 94 and/or coupling components 92.

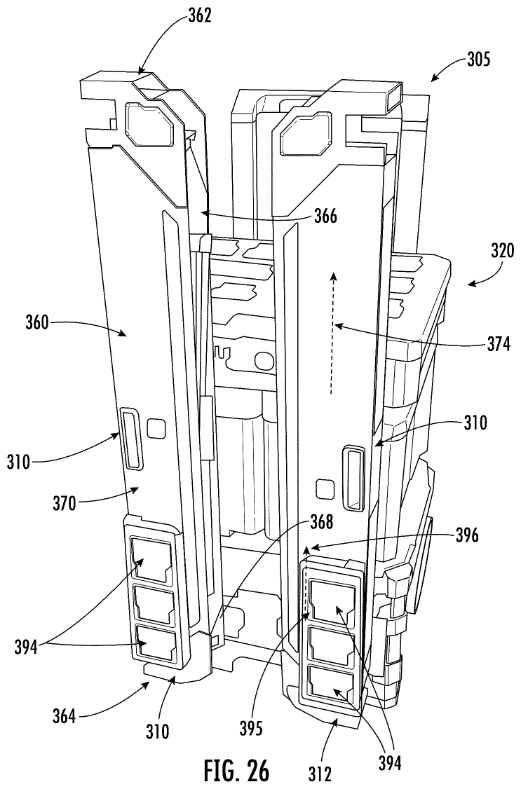

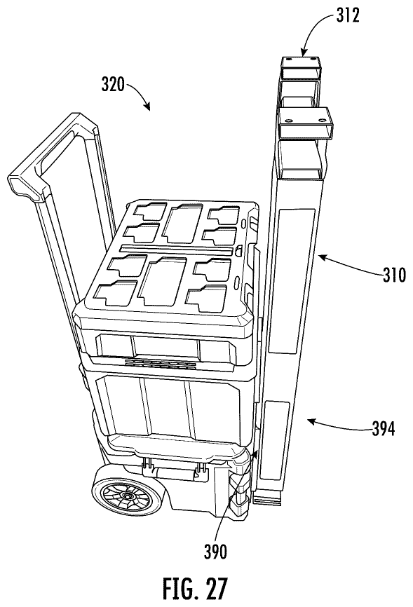

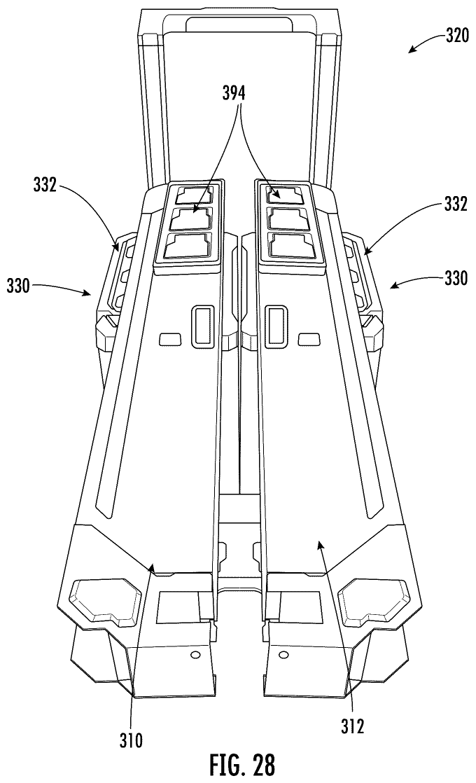

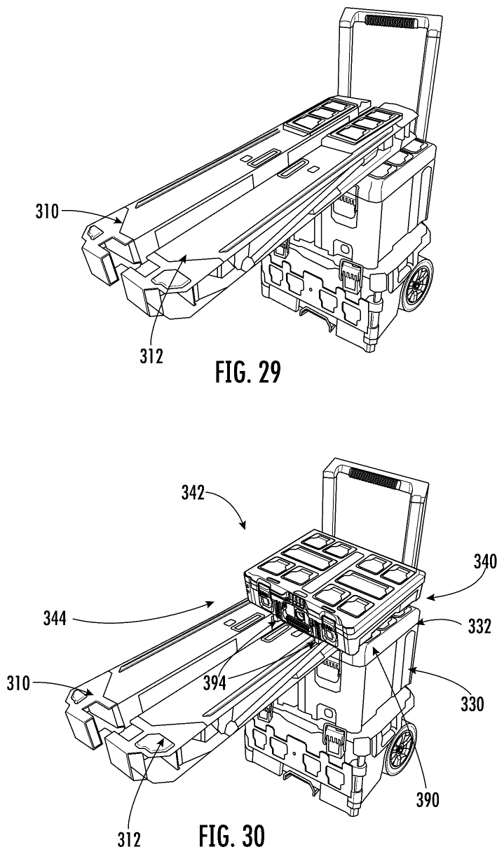

Referring to FIGS. 26-31, various aspects of a support system 305, including two support structures 310, is depicted. Support structure 310 is substantially the same as support structure 10, support structure 110, and support structure 210 except for the differences discussed herein. In particular, support structure 310 is substantially the same as support structure 210 except for the differences discussed herein. Support system 305 includes first support structure 310 and a second support structure 312 coupled together. In various embodiments one or more of first support structure 310 and second support structure 312 include coupling mechanisms to couple to a modular system, shown as modular storage system 320. Support structure 310 can be coupled to various surfaces of modular storage system 320, including without limitation a front surface (FIG. 26) and a top surface (FIG. 28). In a specific embodiment, support structure 310 includes coupling mechanisms on opposing surfaces, thereby permitting support structure 310 to be coupled to a top of modular storage system 320 and a modular unit, shown as modular storage unit 330, to be coupled to a top of support structure 310 (FIG. 30).

Support structure 310 includes housing 360. A first support element, such as a first leg 366, is pivotally coupled to housing 360 at first end 362. A second support element, such as a second leg 368, is pivotally coupled to housing 360 at second end 364. Housing 360 includes first surface 370 and opposing second surface 372.

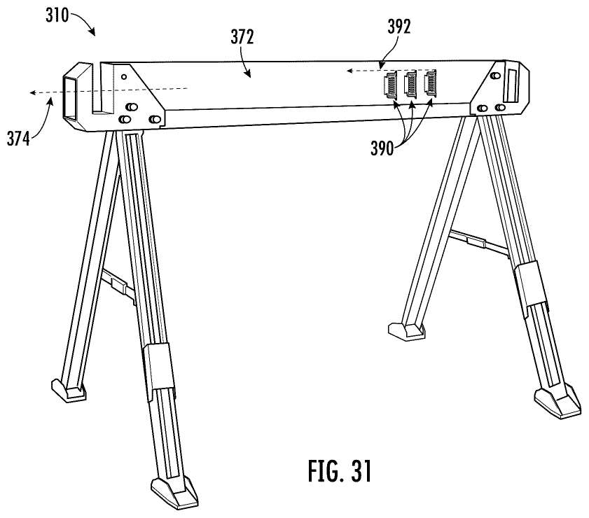

One or more coupling elements, shown as plurality of coupling components 394 (e.g., female couplers), are coupled to first surface 370 of housing 360 of support structure 310. One or more coupling elements, shown as plurality of coupling components 390 (FIG. 31), such as male couplers, are coupled to second surface 372 of housing 360 of support structure 310 opposite the first surface 370. In various embodiments, coupling components 394 are substantially the same as coupling components 94 and/or coupling components 92, and coupling components 390 are substantially the same as coupling components 90.

In various embodiments, coupling components 390 (e.g., male couplers) include tongues that extend along axis 392, which is parallel to longitudinal axis 374 of housing 360, such as the tongues of each of coupling components 390 extend along an axis 392 parallel to axis 374. In various embodiments, coupling components 394 (e.g., female couplers) include ribs 395 that extend along axis 396, which is parallel to longitudinal axis 374 of housing 360.

Referring to FIG. 30, a plurality of coupling components 390 are configured to couple to an upper surface 332 of modular storage unit 330. A plurality of coupling components 394 are configured to couple to a lower surface 344 of a modular storage unit 340 opposite upper surface 342 of modular storage unit 340.

In a specific embodiments, support structure 10, support structure 110, support structure 210, and support structure 310 include one or more coupling components, latches and/or recesses that are compatible with the coupling mechanism(s) described in International Patent Application No. PCT/US2018/044629, which is incorporated herein in its entirety.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A foldable support system comprising:
a first foldable support structure comprising:
a first housing;
a first leg pivotally coupled to a first end of the first housing;
a second leg pivotally coupled to a second end of the first housing opposite the first end, the first leg and the second leg configured to collectively support the first housing;
a first coupling element coupled to the first housing; and
a first female coupler coupled to the first housing, the first female coupler configured to couple to a first surface of a stackable storage unit; and
a second foldable support structure comprising:
a second housing;
a first leg pivotally coupled to a first end of the second housing;
a second leg pivotally coupled to a second end of the second housing opposite the first end, the first leg and the second leg configured to collectively support the second housing;
a second coupling element coupled to the second housing, the second coupling element configured to detachably engage with the first coupling element of the first foldable support structure; and
a second female coupler coupled to the second housing, the second female coupler configured to couple to the first surface of a stackable storage unit.

2. The foldable support system of claim 1, the first foldable support structure comprising a first wheel coupled to the second end of the first housing.

3. The foldable support system of claim 2, the second foldable support structure comprising a second wheel coupled to the second end of the second housing.

4. The foldable support system of claim 1, the first female coupler comprising two ribs extending above and offset from a recessed portion of the first female coupler, and the second female coupler comprising two ribs extending above and offset from a recessed portion of the second female coupler.

5. The foldable support system of claim 4, the first foldable support structure comprising a first wheel coupled to the second end of the first housing, and the second foldable support structure comprising a second wheel coupled to the second end of the second housing, wherein each of the two ribs of the first female coupler extend from a rear wall of the first female coupler along an axis parallel to a longitudinal axis of the first housing, and wherein each of the two ribs of the second female coupler extend from a rear wall of the second female coupler along an axis parallel to a longitudinal axis of the second housing.

6. The foldable support system of claim 1, wherein the first female coupler and the second female coupler are configured to simultaneously couple to the first surface of the stackable storage unit when the first coupling element and the second coupling element are engaged with each other.

7. The foldable support system of claim 1, the first foldable support structure comprising a third coupling element coupled to the first housing, and the second foldable support structure comprising a fourth coupling element coupled to the second housing, the fourth coupling element configured to detachably engage with the third coupling element of the first foldable support structure.

8. A foldable structure comprising:
a housing comprising a first surface and a second surface opposite the first surface;
a first leg pivotally coupled to a first end of the housing;
a second leg pivotally coupled to a second end of the housing opposite the first end, the first leg and the second leg configured to collectively support the housing;
a plurality of male couplers coupled to a first surface of the housing, the plurality of male couplers configured to couple to an upper surface of a stackable storage unit; and
a plurality of female couplers coupled to a second surface of the housing, the plurality of female couplers configured to couple to a lower surface of a stackable storage unit opposite the upper surface.

9. The foldable structure of claim 8, each of the plurality of male couplers comprising a tongue extending from the respective male coupler, the tongue extending above and offset from the first surface of the housing.

10. The foldable structure of claim 9, the housing extending along a first longitudinal axis, wherein for each of the plurality of male couplers, the tongue extends along a second longitudinal axis parallel to the first longitudinal axis.

11. The foldable structure of claim 9, each of the plurality of female couplers comprising a rib above and offset from a recessed portion of the respective female coupler.

12. The foldable structure of claim 8, each of the plurality of female couplers comprising a rib above and offset from a recessed portion of the respective female coupler.

13. The foldable structure of claim 12, the housing extending along a first longitudinal axis, wherein for each of the plurality of female couplers, a rib extends along a third longitudinal axis parallel to the first longitudinal axis.

14. The foldable structure of claim 8, the housing extending along a first longitudinal axis, each of the plurality of female couplers comprises a recessed portion and two ribs above and offset from the recessed portion of the respective female coupler, wherein each of the two ribs extends from a back wall of the respective female coupler along a third longitudinal axis parallel to the first longitudinal axis.

15. The foldable structure of claim 14, each of the plurality of male couplers comprises two tongues above and offset from the housing, wherein each of the two tongues extends along a fourth longitudinal axis parallel to the first longitudinal axis.

16. The foldable structure of claim 8, wherein the first surface of the housing is opposite the second surface of the housing.

17. A foldable support structure comprising:
a first wall;
a second wall movably coupled to the first wall such that the first wall and second wall actuate between an open configuration and a closed configuration, the first wall and the second wall configured to collectively stand in an upright orientation when the second wall and first wall are arranged in the open configuration;
a third wall coupled to the first wall, the third wall configured to interface with the second wall when the second wall and first wall are arranged in the open configuration; and
a first plurality of coupling components extending from one of the first wall, the second wall, and the third wall, the first plurality of coupling components configured to couple to a surface of a stackable storage unit.

18. The foldable support structure of claim 17, the first plurality of coupling components comprising a plurality of female couplers, each of which comprise two ribs extending above and offset from a recessed portion of the respective female coupler.

19. The foldable support structure of claim 18, comprising a plurality of male couplers extending from the third wall, wherein each of the plurality of male couplers comprises two tongues extending above and offset from the third wall.

20. The foldable support structure of claim 19, wherein the plurality of female couplers are configured to couple to a lower surface of the stackable storage unit, and wherein the plurality of male couplers are configured to couple to an upper surface of the stackable storage unit.
